(19) United States
(12) Patent Application Publication
(10) Pub. No.: US 2023/0373414 A1
(43) Pub. Date: Nov. 23, 2023

(54) SYSTEM FOR ROTATABLY MOUNTING AND ELECTRICALLY CONNECTING A COVERING SHELF FOR A MOTOR VEHICLE BOOT

(71) Applicant: Treves Products, Services & Innovation, Paris (FR)

(72) Inventors: Eric Brillon, Paris (FR); Nicolas Guenamant, Paris (FR)

(21) Appl. No.: 18/027,347

(22) PCT Filed: Sep. 30, 2021
(86) PCT No.: PCT/EP2021/077033

§ 371 Date: Mar. 20, 2023

(30) Foreign Application Priority Data
Sep. 30, 2020 (FR) FR2009947

(51) Int. Cl. B60R 16/027; B60R 5/04; H01R 35/04

(52) U.S. Cl. CPC B60R 16/027; B60R 5/044; H01R 35/04

(57) ABSTRACT

The invention relates to a system (1) for rotatably mounting and electrically connecting a covering panel (2) for a motor vehicle boot to a side interior trim (3) of the boot, the system comprising a front zone (4) of the interior trim provided with a pin (5) and a front corner (6) of the panel provided with a means (7) for receiving the pin by interlocking, the means being provided with at least one pair of electrical connectors (10) and the pin being provided with at least one pair of reciprocal connectors (12) which define two non-contiguous strips which follow on from each other and, when viewed in longitudinal vertical cross-section, fall within two opposite angular sectors of the same circle, so as to ensure a connection between the connectors and reciprocal connectors in all the positions occupied by the panel between its covering and access positions.

The invention relates to a system for rotatably mounting and electrically connecting a covering shelf of a motor vehicle boot on a side interior trim of said boot, and also a shelf and an interior trim for such a system.

It is known to make a system for rotatably mounting a covering shelf of a motor vehicle boot on a side interior trim of said boot, said shelf being operable between a horizontal covering position and an inclined position for accessing said boot, said system comprising:
a front zone of said interior trim forming a fastening zone, said zone being provided with a pin projecting transversely from said interior trim,
a front corner of said shelf provided with a means for receiving said pin by interlocking, said means having a C-like general shape defining a housing with a section complementary to that of said pin, the opening of the C having a smaller size than the section of said pin so as to enable a forced insertion of said pin into said housing with a temporary elastic separation of the branches of the C then holding of said pin in said housing.

It is also known to equip the shelf with an electrical device, such as one or more loudspeaker(s) or electrodynamic or magnetostrictive transducer(s), or lighting.

It is then necessary to establish an electrical connection between the shelf and at least one interior trim, in order to be able to connect the electrical device, for example to an amplifier or to the batter of the vehicle.

It should be noted herein that the term “shelf” refers in particular to a shelf mounted at the top of the boot, so as to conceal said boot, but may also refer to a shelf mounted at the bottom of said boot to form a “false floor” allowing in particular concealing a spare wheel.

It is then necessary to meet several requirements:
robustness of the mounting and connection system,
reliability of the connection over time,
operational connection in all of the positions that the shelf could adopt—whose rotation between the covering and access positions is usually done over an angular range much smaller than 90°, being for example in the range of 45°—and that being so despite the transverse dimensional discrepancies that might be observed in the boot from one vehicle to another.

The invention aims to propose a system allowing addressing these different requirements.

To this end, and according to a first aspect, the invention proposes a system for rotatably mounting and electrically connecting a covering shelf of a motor vehicle boot on a side interior trim of said boot, said shelf being operable between a horizontal covering position and an inclined position for accessing said boot, said system comprising:
a front zone of said interior trim forming a fastening zone, said zone being provided with a pin projecting transversely from said interior trim,
a front corner of said shelf provided with a means for receiving said pin by interlocking, said means having a C-like general shape defining a housing with a section complementary to that of said pin, the opening of the C having a smaller size than the section of said pin so as to enable forced insertion of said pin into said housing with temporary elastic spacing of the branches of the C then holding of said pin in said housing,

said system further having the following features:
said means is provided, on the wall of said housing, with at least one pair of electrical connectors intended to be connected to an electrical device mounted on said shelf, said connectors being elastically retractable and projecting towards the inside the C, said connectors substantially facing one another diametrically,
said pin is provided with at least one pair of reciprocal connectors on which each of said connectors bears respectively, said reciprocal connectors defining two separate contact strips disposed according to the same axial positioning, said strips being in line with one another and falling within two opposite angular sectors of the same circle when viewed in longitudinal vertical cross-section, so as to ensure connection between said connectors and reciprocal connectors in all of the positions occupied by said shelf between said covering and access positions.

In this description, the terms regarding positioning in space (longitudinal, transverse, lateral, front, horizontal, vertical, . . . ) are considered with reference to the system in place in the vehicle.

Moreover, the terms referring to an axis (diametrically, axially, . . . ) are considered with reference to the axis of rotation of the shelf.

With the proposed arrangement, a system is provided ensuring:
a robustness of the elements enabling mounting and connection, in particular because the connectors are protected from impacts when the shelf is dismounted, that being so thanks to their location inside the housing,
a reliability of the connection over time, in particular because the connectors bear elastically on the reciprocal connectors
an operational connection in all of the positions that the shelf could adopt, and that being so despite the transverse dimensional discrepancies that might be observed in the boot from one vehicle to another, such operationality being ensured both by the shape of the contact strips defined by the reciprocal connectors (in opposite angular sectors enabling electrical contact in all positions of the shelf), and also by their width defined to compensate for said discrepancies.

According to other aspects, the invention provides a shelf and an interior trim for such a system.

Other particularities and advantages of the invention will appear in the following description, made with reference to the appended figures, wherein:

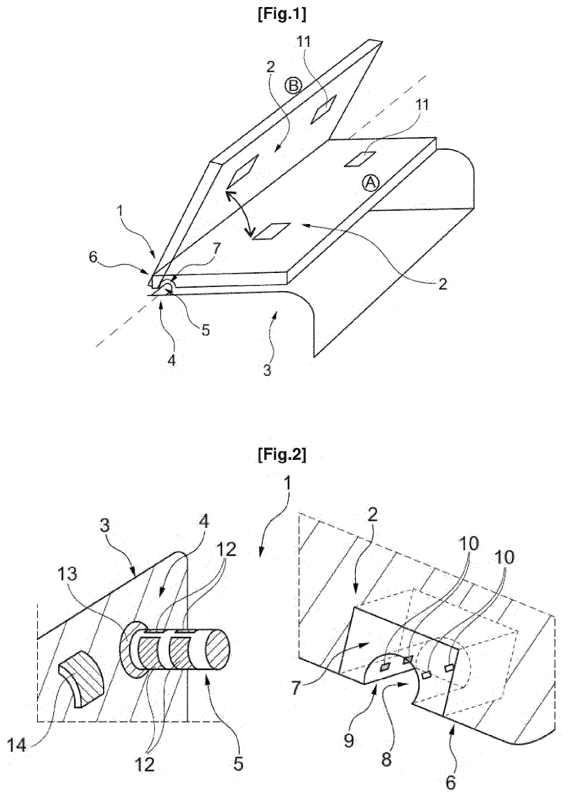

FIG. 1 is a schematic perspective view of a shelf mounted in a vehicle, said shelf being represented in the covering (A) and access (B) position,

FIG. 2 is a schematic perspective and semi-transparent view of a system for mounting and connecting a shelf according to one embodiment, the shelf being dismounted off the interior trim,

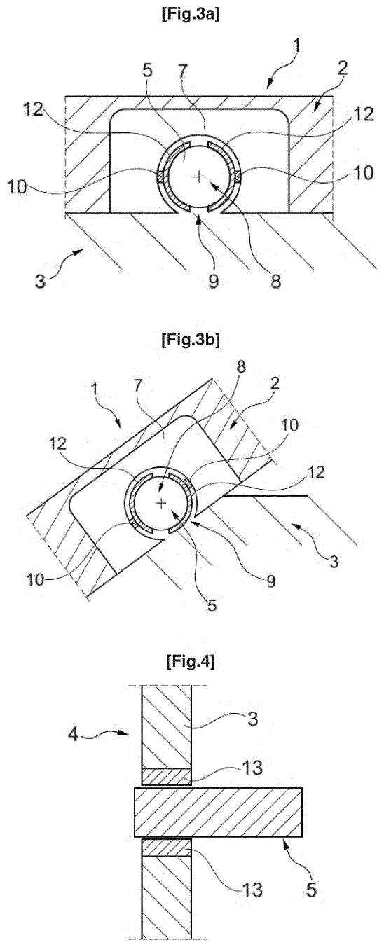

FIG. 3a and

FIG. 3b are schematic longitudinal vertical sectional views of the system of FIG. 2 once the shelf is mounted on the interior trim, said shelf being in the covering position (FIG. 3a) and in the access position (FIG. 3b),

FIG. 4 is a schematic partial cross-sectional view of the system of FIG. 2.

Referring to the figures, a system 1 is described for rotatably mounting and electrically connecting a covering shelf 2 of a motor vehicle boot on a side interior trim 3 of said boot, said shelf being operable between a horizontal covering position and an inclined position for accessing said boot, said system comprising:
a front zone 4 of said interior trim forming a fastening zone, said zone being provided with a pin 5—in particular made of moulded plastic material—projecting transversely from said interior trim,
a front corner 6 of said shelf provided with a means 7 for receiving said pin by interlocking, said means—in particular made of moulded plastic material—having a C-like general shape defining a housing 8 with a section complementary to that of said pin—the C being herein turned by a quarter turn to present its opening 9 downwards—, the opening 9 of the C having a smaller size than the section of said pin so as to enable forced insertion of said pin into said housing with temporary elastic separation of the branches of the C then holding of said pin in said housing,

said system further having the following features:
said means is provided, on the wall of said housing, with at least one pair of electrical connectors 10 intended to be connected to an electrical device 11—for example a loudspeaker, a transducer or a lighting—mounted on said shelf, said connectors being elastically retractable and projecting towards the inside the C, said connectors substantially facing one another diametrically,
said pin is provided with at least one pair of reciprocal connectors 12 on which each of said connectors bears respectively, said reciprocal connectors defining two separate contact strips disposed according to the same axial positioning, said strips being in line with one another and falling within two opposite angular sectors of the same circle when viewed in longitudinal vertical cross-section, so as to ensure connection between said connectors and reciprocal connectors in all of the positions occupied by said shelf between said covering and access positions.

According to the represented embodiment, the system 1 comprises two pairs of connectors 10 cooperating with two respective pairs of reciprocal connectors 12, said pairs of connectors and reciprocal connectors being staged axially one after another.

With such an arrangement, it is possible to provide for equipping the shelf 2 with two electrical devices 11 powered independently of each other.

In the case of devices 11 such as loudspeakers or transducers, a stereophonic effect can thus be achieved.

In a non-represented variant, it is possible to provide for disposing a pair of connectors 10 in each front corner 6 of the shelf 2, said connectors cooperating with reciprocal connectors 12 located on two side interior trims 3.

According to the represented embodiment, the connectors 10 are in the form of blades made of spring metal.

According to the represented embodiment, the system 1 further comprises an elastic decoupling means 13—herein in the form of a sleeve made of rubber—interposed between the pin 5 and the fastening zone 4, such an arrangement turning out to be particularly suitable in the case of a transducer-type electrical device 11.

According to the represented embodiment, the system 1 further comprises a transverse centring means 14—in the form of a blade made of spring metal according to the represented embodiment, or of a spring-mounted stud in a non-represented variant, or else of an elastically-compressible stud in another non-represented variant—of the shelf 2, said means being located either in the fastening zone 4 of the interior trim, according to the represented embodiment, or in the front corner 6 of said shelf, according to a non-represented embodiment, said means being intended to cooperate with a similar means respectively provided either on another interior trim provided on the other side of the boot or on the other front corner of said shelf.

The implementation of such a centring means 14 contributes overcoming the transverse dimensional discrepancies observed on boots from one vehicle to another.

According to one embodiment, a strip defined by a reciprocal connector 12 has a minimum width (corresponding to its axial dimension) of 7 mm, such a width allowing absorbing the dispersals usually observed.

A shelf 2 for such a system 1 is now described, a front corner 6 of said shelf being provided with a receiving means 7 intended to receive a pin 5 projecting from a side interior trim 3 by interlocking, said means having a C-like general shape defining a housing 8, said means being provided, on the wall of said housing, with at least one pair of electrical connectors 10, said connectors being elastically retractable and projecting towards the inside of the C, said connectors substantially facing one another diametrically, said shelf being further provided with an electrical device 11 (loudspeaker, transducer, lighting, . . . ) connected to said connectors.

Finally, a side interior trim 3 of a motor vehicle boot for such a system 1 is described, a front zone 4 of said interior trim forming a fastening zone, said zone being provided with a pin 5 projecting transversely from said interior trim, said pin being provided with at least one pair of reciprocal connectors 12—intended for example to be connected to an amplifier or to a battery—on which a pair of connectors 10 projecting from a shelf 2 are intended to come into contact, said reciprocal connectors defining two separate contact strips disposed according to the same axial positioning, said strips being in line with one another and falling within two opposite angular sectors of the same circle when viewed in longitudinal vertical cross-section.

1. A system for rotatably mounting and electrically connecting a covering shelf of a motor vehicle boot on a side interior trim of said boot, said shelf being operable between a horizontal covering position and an inclined position for accessing said boot, said system comprising:
a front zone of said interior trim forming a fastening zone, said zone being provided with a pin projecting transversely from said interior trim,
a front corner of said shelf provided with a means for receiving said pin by interlocking, said means having a C-like general shape defining a housing with a section complementary to that of said pin, the opening of the C having a smaller size than the section of said pin so as to enable forced insertion of said pin into said housing with temporary elastic separation of the branches of the C then holding of said pin in said housing, wherein:
said means is provided, on the wall of said housing, with at least one pair of electrical connectors intended to be connected connectable to an electrical device mounted on said shelf, said connectors being elastically retractable and projecting towards the inside the C, said connectors substantially facing one another diametrically,
said pin is provided with at least one pair of reciprocal connectors on which each of said connectors bears respectively, said reciprocal connectors defining two separate contact strips disposed according to the same axial positioning, said strips being in line with one another and falling within two opposite angular sectors of the same circle when viewed in longitudinal vertical cross-section, so as to ensure connection between said connectors and reciprocal connectors in all of the positions occupied by said shelf between said covering and access positions.

2. The system according to claim 1, further comprising two pairs of connectors cooperating with two respective pairs of reciprocal connectors, said pairs of connectors and reciprocal connectors being staged axially one after another.

3. The system according to claim 1, the connectors being in the form of blades made of spring metal.

4. The system according to claim 1, further comprises further comprising an elastic decoupling means interposed between the pin and the fastening zone.

5. The system according to claim 1, further comprising a means for transversely centering the shelf, said means being located either in the fastening zone of the interior trim or in the front corner of said shelf, said means being intended to cooperate with a similar means provided respectively either on another interior trim provided on the other side of the boot or on the other front corner of said shelf.

6. The system according to claim 1, wherein a strip defined by a reciprocal connector has a minimum width of 7 mm.

7. A shelf for a system according to claim 1, a front corner of said shelf being provided with a receiving means adapted to receive a pin projecting from a side interior trim by interlocking, said means having a C-like general shape defining a housing, said means being provided, on the wall of said housing, with at least one pair of electrical connectors, said connectors being elastically retractable and projecting towards the inside of the C, said connectors substantially facing one another diametrically, said shelf being further provided with an electrical device connected to said connectors.

8. A side interior trim of a motor vehicle boot for a system according to claim 1, a front zone of said interior trim forming a fastening zone, said zone being provided with a pin projecting transversely from said interior trim, said pin of the interior trim being provided with at least one pair of reciprocal connectors on which a pair of connectors projecting from a shelf are intended to come into contact, said reciprocal connectors defining two separate contact strips disposed according to the same axial positioning, said strips being in line with one another and falling within two opposite angular sectors of the same circle when viewed in longitudinal vertical cross-section.
